(19) United States
(12) Patent Application Publication
(10) Pub. No.: US 2024/0355563 A1
(43) Pub. Date: Oct. 24, 2024

(54) SWITCHING DEVICE FOR A MEDIUM-VOLTAGE ELECTRICAL CIRCUIT

(71) Applicant: Schneider Electric Industries SAS, Rueil Malmaison (FR)

(72) Inventor: Vladislav Kraynov, Grenoble (FR)

(73) Assignee: Schneider Electric Industries SAS, Rueil Malmaison (FR)

(21) Appl. No.: 18/628,946

(22) Filed: Apr. 8, 2024

(30) Foreign Application Priority Data
Apr. 20, 2023 (FR) 2303987

(51) Int. Cl. H01H 33/662; H01H 33/02; H01H 33/664; H01H 33/666

(52) U.S. Cl. CPC H01H 33/66207; H01H 33/022; H01H 33/664; H01H 2033/6667

(57) ABSTRACT

A switching device for a medium-voltage electrical circuit including: a frame; a vacuum circuit breaker including a fixed electrode relative to the frame and a mobile electrode; an elastic member; and an actuating lever connected to the mobile electrode via the elastic member, The actuating lever is movable between an open position in which the electrodes are separated by an open distance, and a closed position in which the electrodes are in contact. A passage of the actuating lever from the open position to the closed position defines a displacement stroke, greater than the open distance such that the elastic member is compressed when the actuating lever passes from the first position to the second position. The switching device includes at least one removable spacer arranged between the frame and the fixed electrode.

### TECHNICAL FIELD

The present invention relates to the field of vacuum switching devices. These vacuum switching devices are, for example, used in medium-voltage, that is to say from 1 to 52 kV, electrical distribution units.

These devices make it possible to close and to open each phase of the electrical circuit, and comprise vacuum circuit breakers, also called vacuum interrupters.

### PRIOR ART

The vacuum circuit breaker comprises a fixed electrode and a mobile electrode which is connected to a control lever. The control lever is mobile between two end positions defining a constant actuation stroke. By actuating the control lever, the mobile electrode is moved and may be separated from the fixed electrode or placed in contact with the latter, this opening or closing the electrical circuit.

When the circuit is closed and the electrodes are in contact, sufficient contact pressure has to be ensured between the two electrodes, in order to resist the repelling forces present between them due to the flow of the current.

To ensure this contact pressure, a spring is present in the kinematic linkage between the control lever and the mobile electrode, and the stroke of the control lever is greater than the minimum stroke for ensuring contact between the electrodes of the vacuum circuit breaker. The overstroke of the control lever therefore allows the spring to be compressed and a desired minimum contact pressure thus to be applied. The stroke required to obtain contact between the electrodes of the vacuum circuit breaker increases over time, due to the erosion of the contacts, the wear of the kinematic linkage and the creep of certain components arising over the use of the switching device. Consequently, the overstroke of the control lever decreases, that is to say that the compression of the spring creating the contact pressure created by the spring also decreases. The contact pressure between the electrodes therefore decreases over the life of the product.

When the contact pressure between the electrodes becomes insufficient, operation of the switching device is no longer satisfactory. It then becomes necessary to carry out a major overhaul of the switching device in order to change the defective elements. This procedure is costly both in terms of material and intervention time. Furthermore, the device is unavailable for a significant amount of time.

It is therefore desirable to have a solution making it possible to prolong the possible service life before a major overhaul of the switching device.

### SUMMARY

To this end, the invention proposes a switching device for a medium-voltage electrical circuit, comprising:
a frame,
a vacuum circuit breaker comprising a fixed electrode relative to the frame and a mobile electrode,
an elastic member,
an actuating lever connected to the mobile electrode via the elastic member,
   the actuating lever being movable between a first position called open position in which the mobile electrode and the fixed electrode are separated by an open distance, and a second position called closed position in which the mobile electrode and the fixed electrode are in contact so as to allow current to flow through the electrical circuit,
   a passage of the actuating lever from the first position to the second position defining a displacement stroke,
   the displacement stroke of the actuating lever being greater than the open distance such that the elastic member is compressed when the actuating lever passes from the first position to the second position,
   wherein the switching device comprises at least one removable spacer arranged between the frame and the fixed electrode so as to adjust the distance between the fixed electrode and the frame by removing the removable shim.

The removable spacer adds to the distance between the fixed electrode and the frame along the displacement axis of the mobile electrode.

The removable spacer may be mounted on the switching device, or removed from the switching device. The removable spacer may be removed in a simple manner by an operator.

The open distance between the electrodes may thus be adjusted depending on whether the removable spacer is mounted or removed. Specifically, when the removable spacer is not present, the distance between the fixed electrode and the frame is less than when the removable spacer is present, since the thickness of the removable spacer is no longer involved in the stack of dimensions between the fixed electrode and the frame. The position of the mobile electrode with respect to the frame remains unchanged whether the removable spacer is present or not. Thus, the open distance between the electrodes decreases when the removable spacer is removed.

In other words, removing the spacer counteracts the loss of contact overstroke originating in particular from the wear of the contacts of the electrodes. The overstroke of the actuating lever increases, this making it possible to increase the contact pressure ensured by the elastic member. The service life of the switching device may thus be prolonged by removing the removable spacer.

The features listed in the following paragraphs may be implemented independently of one another or in any technically possible combination:

According to one aspect of the switching device, the elastic member exerts a repelling force between the mobile electrode and the actuating lever.

The elastic member is prestressed.

The stroke of the actuating lever is fixed.

The actuating lever is in pivot connection with respect to the frame.

The fixed electrode is rigidly connected to the frame.

The fixed electrode and the mobile electrode are coaxial.

The mobile electrode is mobile in translation along the shared axis of the electrodes.

According to one embodiment, the switching device comprises a device for determining a difference between the displacement stroke of the actuating lever and the open distance of the mobile electrode with respect to the fixed electrode.

By tracking the change in the overstroke of the actuating lever over time, it is possible to detect precisely at which point in time the removal of the removable spacer is opportune.

According to one aspect of the switching device, the actuating lever is connected to the mobile electrode via an insulator.

According to another aspect of the switching device, the actuating lever is connected to the mobile electrode via a control plate in pivot connection with the control lever.

According to one embodiment of the switching device, the elastic member is arranged between the control plate and the insulator. The insulator is rigidly connected to the mobile electrode.

According to another embodiment of the switching device, the elastic member is arranged between the insulator and the mobile electrode. The control plate is rigidly connected to the insulator.

The pivot axis of the control lever with respect to the frame and the pivot axis of the control plate with respect to the control lever are parallel.

The device for determining a difference between the displacement stroke of the actuating lever and the open distance of the mobile electrode comprises a position measurement device which is set up to determine the relative position of the mobile electrode with respect to the control plate.

The switching device comprises a receiving enclosure fixed to the frame. The vacuum circuit breaker is arranged in the receiving enclosure. The fixed electrode is rigidly connected to the receiving enclosure.

The receiving enclosure is formed of an electrically insulating material.

The insulator is arranged at least partly in the receiving enclosure.

The insulator is arranged entirely in the receiving enclosure.

Part of the electrical circuit is arranged in the enclosure.

According to one embodiment of the switching device, the at least one removable spacer is arranged between the receiving enclosure and the frame.

No modification to the frame or to the receiving enclosure is necessary.

The removable spacer is made of metal.

The removable spacer is, for example, made of stainless steel.

The removable spacer is planar.

The removable spacer is formed by cutting a metal sheet.

The removable spacer has a thickness comprised between 0.5 millimetres and 2 millimetres.

According to one exemplary embodiment of the switching device, the at least one removable spacer is arranged between a fixing flange, for fixing the receiving enclosure to the frame, and the frame.

A first face of the removable spacer is in contact with the frame. A second face of the removable spacer, opposite to the first face, is in contact with the fixing flange.

The removable spacer is compressed between the fixing flange and the frame when the switching device is in an operational state.

According to another exemplary embodiment of the switching device, the receiving enclosure comprises a first portion fixed to the frame and a second portion fixed to the first portion, and the at least one removable spacer is arranged between the first portion and the second portion of the receiving enclosure.

In this case, a first face of the removable spacer is in contact with the first portion. A second face of the removable spacer, opposite to the first face, is in contact with the second portion of the receiving enclosure.

The removable spacer is compressed between the first portion and the second portion when the switching device is in an operational state.

According to one exemplary implementation of the switching device, a lateral edge of the removable spacer is flush with a lateral edge of the fixing flange.

According to one embodiment variant, a lateral edge of the removable spacer protrudes from a lateral edge of the fixing flange.

It is thus easy to check for the presence or absence of the removable spacer, since the lateral edge of the spacer protrudes beyond the fixing flange, or is flush with the latter. The edge of the spacer can therefore be easily seen by an operator when the spacer is present. Likewise, the absence of the spacer is easy to notice. Monitoring operations are thus made easier.

According to one exemplary embodiment, the fixing flange of the receiving enclosure has the general shape of a rectangle.

According to one embodiment of the switching device, the at least one removable spacer comprises a notch for passage of a fixing means for fixing the receiving enclosure to the frame.

The notch extends along a direction transverse to a main axis of the removable spacer.

The spacer may thus be put in place without completely removing the fixing means, which simply have to be loosened in order to allow the insertion of the spacer. In the same way, the spacer may be withdrawn without removing the fixing means.

According to one exemplary embodiment, the fixing flange of the receiving enclosure has a rectangular shape and comprises four fixing means for fixing to the frame. Each fixing means is arranged substantially at a corner of the rectangle defined by the fixing flange.

According to one embodiment of the switching device, the at least one removable spacer comprises a first plate and a second plate, each plate comprising a first notch for passage of a first fixing means for fixing the receiving enclosure to the frame and a second notch for passage of a second fixing means for fixing the receiving enclosure to the frame.

The first plate is arranged facing a first lateral edge of the fixing flange and the second plate is arranged facing a second lateral edge of the fixing flange.

When the fixing flange has a rectangular or square shape and comprises four fixing means, a spacer comprising two plates may be easily arranged and ensures a good contact surface with the frame, on the one hand, and with the fixing flange, on the other hand.

The two plates are, for example, planar.

The two planar plates are, for example, identical.

Each plate comprises a straight edge which is set up to be flush with a lateral edge of the fixing flange when the plate is present between the frame and the receiving enclosure.

According to one embodiment, the at least one removable spacer comprises an L-shaped portion, the L-shaped portion comprising three notches for passage of a fixing means.

According to one embodiment, the at least one removable spacer comprises a U-shaped portion.

According to another embodiment variant, the at least one removable spacer is U-shaped and comprises two parallel branches connected by a base extending transversely across the branches, each branch comprising a passage notch for the passage of the fixing means.

According to one embodiment of the switching device, the at least one removable spacer comprises a stack of at least two plates.

The removable spacer comprises two superposed, that is to say stacked, plates.

In this case, it is possible, over the course of the life of the switching device, to remove a first plate so as to compensate for a first level of loss of overstroke of the contacts of the electrodes. Later, the second plate is removed in turn, so as to compensate for a second level of loss of contact overstroke. The operation of compensating for the wear may thus be carried out twice, this making it possible to compensate for a larger amount of loss of contact overstroke.

The disclosure likewise relates to a three-phase medium-voltage electrical unit, comprising for each phase a switching device as described above.

According to one embodiment of the electrical unit, each switching device comprises at least one removable spacer which is separate from the at least one removable spacer of the other switching devices.

According to another embodiment, the electrical unit comprises at least one removable spacer which is shared by the three switching devices.

### BRIEF DESCRIPTION OF THE DRAWINGS

Further features, details and advantages will become apparent from reading the following detailed description and from studying the attached drawings in which:

FIG. 1 is a basic diagram illustrating the operation of a switching device according to a first embodiment,

FIG. 2 is another basic diagram of a switching device according to the first embodiment,

FIG. 3 is a perspective partial view of an electrical unit comprising a switching device,

FIG. 4 is another perspective partial view of an electrical unit comprising a switching device according to the first embodiment,

FIG. 5 is a perspective view of one embodiment of a removable spacer which may be integrated into the switching device of FIG. 4,

FIG. 6 is a partial view, from below, of a switching device comprising a removable spacer according to one embodiment variant,

FIG. 7 is a plan view of another embodiment variant of a removable spacer which may be integrated into the proposed switching device,

FIG. 8 is a partial view, in cross section, of the electrical unit of FIGS. 3 and 4,

FIG. 9 is a basic diagram of a switching device according to a second embodiment.

### DESCRIPTION OF THE EMBODIMENTS

To make the figures easier to read, the various elements are not necessarily drawn to scale. In these figures, elements that are identical bear the same references. Certain elements or parameters may be indexed, that is to say designated for example by first element or second element, or even first parameter and second parameter, etc. The aim of this indexing is to differentiate between elements or parameters that are similar but not identical. This indexing does not imply that one element or parameter takes priority over another, and the denominations may be interchanged. Where it is specified that a subsystem comprises a given element, that does not exclude there being other elements present in that subsystem. Similarly, when it is specified that a subsystem comprises a given element, it is understood that the subsystem comprises at least this element.

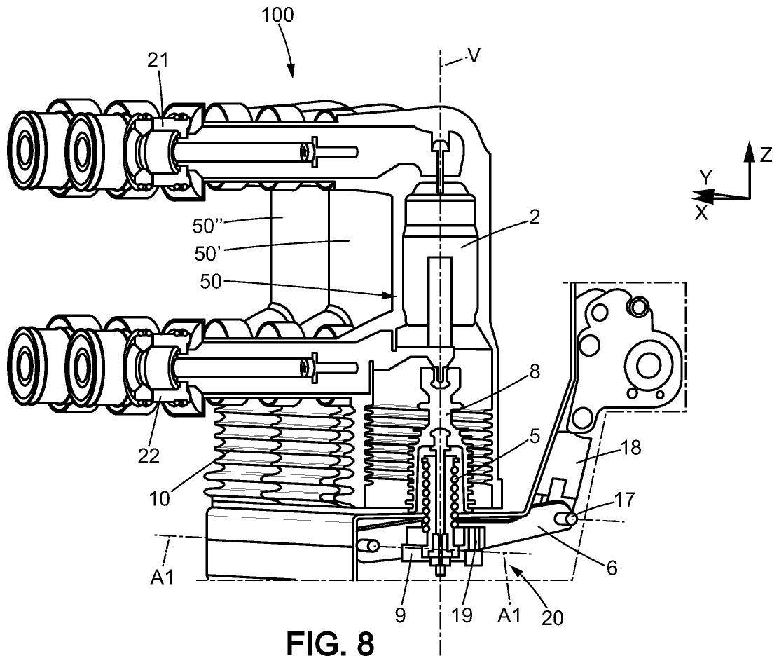

FIG. 8 shows a three-phase medium-voltage electrical unit 100.

Medium voltage is understood to mean a voltage of between 1 kV and 52 kV. The electrical unit 100 comprises for each phase a switching device 50, 50′, 50″ which will be described in detail below.

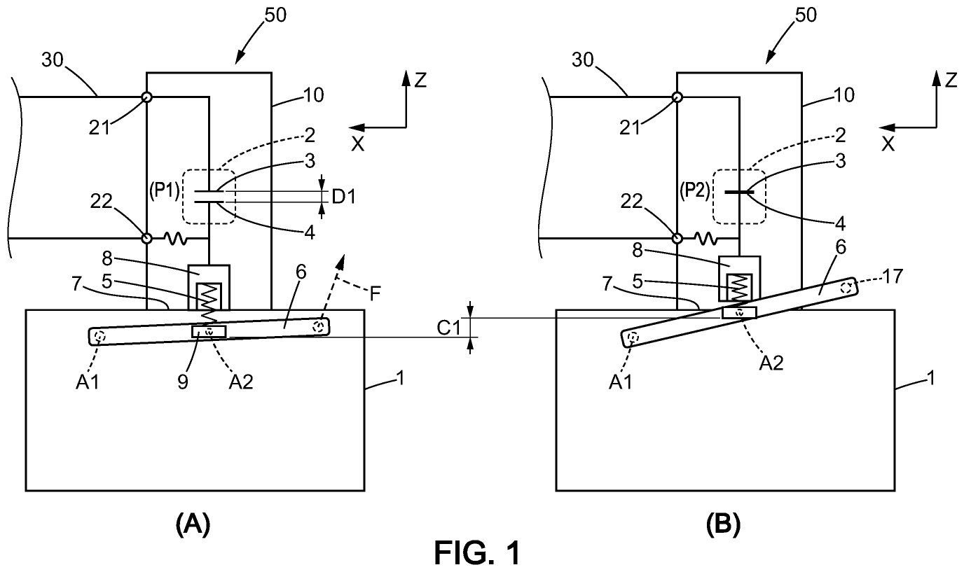

FIG. 1 schematically shows a switching device 50 for a medium-voltage electrical circuit 30.

The switching device 50 comprises:
a frame 1,
a vacuum circuit breaker 2 comprising a fixed electrode 3 relative to the frame 1 and a mobile electrode 4,
an elastic member 5,
an actuating lever 6 connected to the mobile electrode 4 via the elastic member 5.

The actuating lever 6 is movable between a first position called open position P1 in which the mobile electrode 4 and the fixed electrode 3 are separated by an open distance D1, and a second position called closed position P2 in which the mobile electrode 4 and the fixed electrode 3 are in contact so as to allow current to flow through the electrical circuit 30.

A passage of the actuating lever 6 from the first position P1 to the second position P2 defines a displacement stroke C1.

The displacement stroke C1 of the actuating lever 6 is greater than the open distance D1 such that the elastic member 5 is compressed when the actuating lever 5 passes from the first position P1 to the second position P2.

The switching device 50 comprises at least one removable spacer 7 arranged between the frame 1 and the fixed electrode 3 so as to adjust the distance between the fixed electrode 3 and the frame 1 by removing the removable shim 7.

The term “removable” is understood to mean that the switching device 50 is able to operate with the spacer 7 present in the switching device, or absent from the switching device.

In other words, the removable spacer 7 may be mounted on the switching device 50, or removed from the switching device 50. The removable spacer 7 may be removed in a simple manner by an operator.

The removable spacer 7 is a shim of a certain thickness.

In the sense of the present patent application, the terms “removable shim” and “removable spacer” are equivalent.

The removable spacer 7 adds to the distance between the fixed electrode 3 and the frame 1 along the displacement axis V of the mobile electrode 4.

The removable spacer 7 is thus part of the chain of dimensions defining the open distance D1 between the mobile electrode 4 and the fixed electrode 3.

The open distance D1 between the electrodes 3, 4 may thus be adjusted depending on whether the removable spacer 7 is present or absent, that is to say mounted or removed.

Specifically, when the removable spacer 7 is not present, the distance between the fixed electrode 3 and the frame 1 is less than when the removable spacer 7 is present, since the thickness e of the removable spacer 7 is no longer involved in the chain of dimensions between the fixed electrode 3 and the frame 1. The position of the mobile electrode 4 with respect to the frame 1 remains unchanged whether the removable spacer 7 is present or not. Thus, the open distance D1 between the electrodes 3, 4 decreases when the removable spacer 7 is removed. In other words, removing the spacer 7 counteracts the loss of contact overstroke originating in particular from the wear of the contacts of the electrodes 3, 4. The overstroke of the actuating lever 6 increases when the spacer 7 is removed, this making it possible to increase the contact pressure ensured by the elastic member 5. The service life of the switching device 50 may thus be prolonged by removing the removable spacer 7.

The switching device 50 comprises a receiving enclosure 10 fixed to the frame 1. The receiving enclosure 10 is formed of an electrically insulating material.

The receiving enclosure 10 is, for example, made of epoxy resin or of a thermoplastic material.

The receiving enclosure 10 is commonly denoted by the term “pole”.

The vacuum circuit breaker 2 is arranged in the receiving enclosure 10. The fixed electrode 3 is rigidly connected to the receiving enclosure 10.

Likewise, the body of the vacuum circuit breaker 2 is rigidly connected to the receiving enclosure 10.

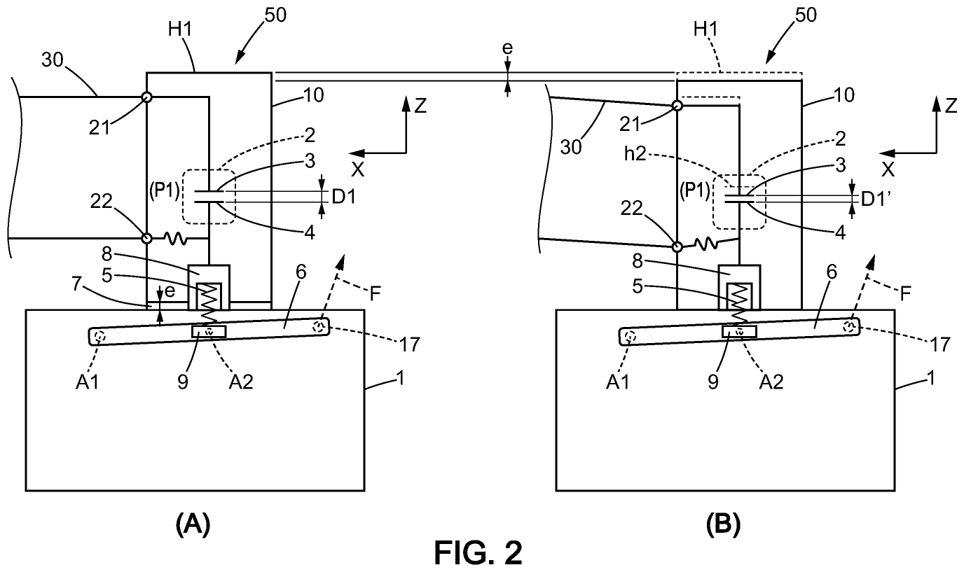

FIG. 2 illustrates the open distance between the electrodes 3, 4 depending on whether the removable spacer 7 is in a so-called mounted state or in a so-called removed state.

“Mounted” state is understood to mean a state in which the removable spacer 7 is present in the switching device 50.

“Removed” state is understood to mean a state in which the removable spacer 7 is absent from the switching device 50.

In part A of FIG. 2, the spacer 7 is present, and the open distance between the electrodes 3, 4 is indicated by the value D1. The thickness e of the spacer 7 has been exaggerated in order to improve the readability of the figure.

In part B of FIG. 2, the spacer 7 is not present.

The position of the actuating lever 6 is unchanged between part A and part B, and corresponds to the open position P1.

The open distance between the electrodes 3, 4 when the removable spacer is not present is indicated by the value D1′. This value D1′ is less than the value D1, and differs from the value of the thickness e of the spacer 7.

The dashed lines denoted by the signs h1, h2 respectively represent the position of the top of the enclosure 10 and the position of the fixed electrode 3 when the removable spacer 7 is mounted, as is the case in part A.

The natural elasticity of the conductive bar connected to the lower contact 22, symbolized by the wave shape, makes it possible to compensate for the change in the position of the enclosure 10 when the spacer 7 is removed.

In the new state of the switching device 50, the removable spacer 7 is mounted, as schematized in part A of FIG. 2. Over the course of the use of the switching device 50, when the monitoring operations carried out show that the loss of contact overstroke has reached a certain threshold, the removable spacer 7 is removed so as to decrease the open distance D1 between the electrodes, as schematized in part B of FIG. 2. The overstroke of the actuating lever 6 is thus increased, and consequently the contact pressure between the electrodes 3, 4 ensured by the elastic member 5.

The removable spacer 7 is a shim of a certain thickness.

The elastic member 5 exerts a repelling force between the mobile electrode 4 and the actuating lever 6.

The elastic member 5 is prestressed.

In other words, the elastic member 5 is in a compressed position when the fixed electrode 3 and the mobile electrode 4 are at a distance from one another.

The more the elastic member 5 is compressed, the more the stored potential energy increases.

The stroke of the actuating lever 6 is fixed.

In other words, the kinematics of the one or more actuators causing the movement of the actuating lever are not adjustable.

The actuating lever 6 is in pivot connection with respect to the frame 1. The sign A1 illustrates the pivot axis of the actuating lever 6.

The actuating lever 6 makes it possible to control the opening and the closing of the vacuum circuit breaker 2, and thus of the electrical circuit 30. The actuating lever 6 is mobile in rotation about an axis A1.

As can be seen in FIG. 8, a drive rod 17, secured to an actuator 18, passes through a portion of the actuating lever 6 in the opposite direction to the pivot axis A1, and may drive the actuating lever 6 to rotate. The arrow F schematically indicates the direction of the force applied by the actuator 18 when the vacuum circuit breaker 2 is being closed.

The fixed electrode 3 is rigidly connected to the frame 1.

The fixed electrode 3 and the mobile electrode 4 are coaxial.

Each electrode 3, 4 comprises a disc-shaped electrical contact secured to a cylindrical rod. The electrical contacts of the two electrodes 3, 4 face one another.

The disc-shaped portion of the mobile electrode 4 may come into contact with the disc-shaped portion of the fixed electrode 3, so as to allow electrical current to flow between the electrodes, and therefore through the vacuum circuit breaker 2 and the circuit 30.

The mobile electrode 4 is mobile in translation along the shared axis of the electrodes. When the disc-shaped portion of the mobile electrode 4 is at a distance from the disc-shaped portion of the fixed electrode 3, the current is interrupted in the circuit 30.

According to the illustrated example, the switching device 50 comprises a device 20 for determining a difference between the displacement stroke C1 of the actuating lever 6 and the open distance D1 of the mobile electrode 4 with respect to the fixed electrode 3.

The determined difference corresponds to the overstroke of the actuating lever 6. By tracking the change in the overstroke of the actuating lever 6 over time, it is possible to detect precisely at which point in time the removal of the removable spacer 7 is opportune.

The actuating lever 6 is connected to the mobile electrode 4 via an insulator 8. The insulator 8 is arranged at least partly in the receiving enclosure 10.

Preferably, the insulator 8 is arranged entirely in the receiving enclosure 10.

The actuating lever 6 is likewise connected to the mobile electrode 4 via a control plate 9 in pivot connection with the control lever 6.

The sign A2 schematically illustrates the pivot axis of the control plate 9 with respect to the actuating lever 6.

According to the illustrated example, the elastic member 5 is arranged between the control plate 9 and the insulator 8. The insulator 8 is rigidly connected to the mobile electrode 4.

According to another embodiment of the switching device 50, not illustrated, the elastic member 5 is arranged between the insulator 8 and the mobile electrode 4. The control plate 9 is rigidly connected to the insulator 8.

The pivot axis A1 of the control lever 6 with respect to the frame 1 and the pivot axis A2 of the control plate 9 with respect to the control lever 6 are parallel.

The displacement stroke C1 of the actuating lever 6 is the stroke needed to displace the mobile electrode 4, that is to say the stroke of the control plate 9 along the direction of translation V of the mobile electrode 4.

The device 20 for determining a difference between the displacement stroke C1 of the actuating lever 6 and the open distance D1 of the mobile electrode 4 comprises a position measurement device 19 which is set up to determine the relative position of the mobile electrode 4 with respect to the control plate 9.

Various embodiments are possible for the device 20 and the position measurement device 19, and will not be described in detail.

Part of the electrical circuit 30 is arranged in the enclosure 10.

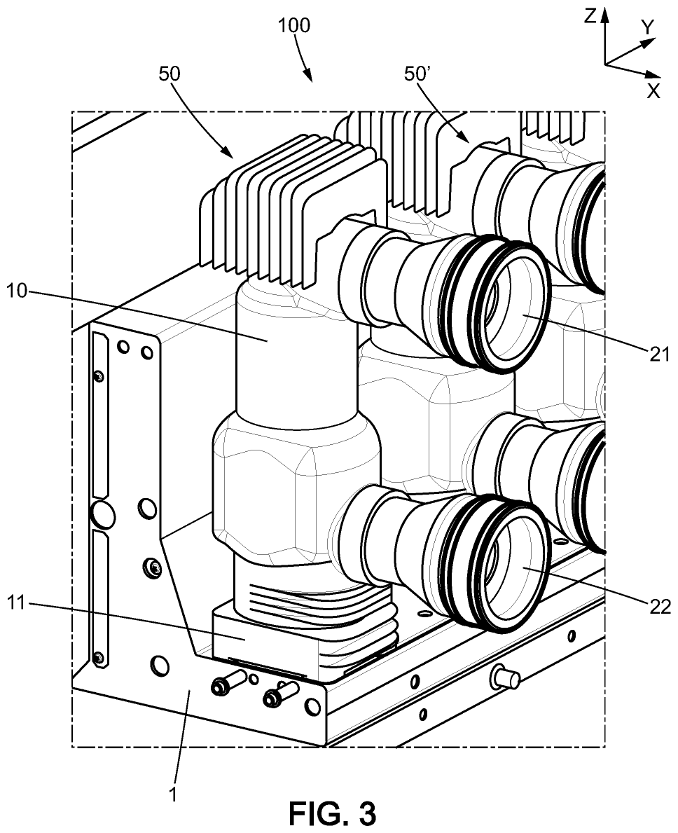

The enclosure 10, one exemplary embodiment of which is shown in FIG. 3, has the general shape of a tube closed at one of its ends.

The electrical conductors 21, 22 respectively connected to each electrode of the vacuum circuit breaker 2 each pass through the lateral wall of the tube.

The connection between this lateral wall and each electrical conductor is tight.

The open end of the tube faces the frame 1.

According to one embodiment of the switching device 50, the at least one removable spacer 7 is arranged between the receiving enclosure 10 and the frame 1. No modification to the frame 1 or to the receiving enclosure 10 is necessary in order to put the removable spacer 7 in place.

This setup is that illustrated in FIGS. 1 and 2.

The removable spacer 7 is made of metal here.

The removable spacer 7 is, for example, made of stainless steel.

The removable spacer 7 is planar.

The removable spacer 7 is, for example, formed by cutting a metal sheet.

The removable spacer 7 has a thickness e comprised between 0.5 millimetres and 2 millimetres.

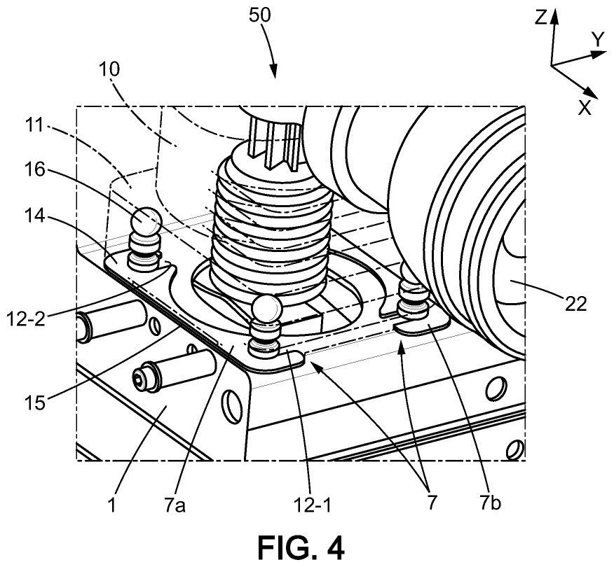

FIG. 4 illustrates one exemplary embodiment of the switching device 50, wherein the at least one removable spacer 7 is arranged between a fixing flange 11, for fixing the receiving enclosure 10 to the frame, and the frame 1.

A first face of the removable spacer 7 is in contact with the frame 1. A second face of the removable spacer 7, opposite to the first face, is in contact with the fixing flange 11.

The removable spacer 7 is compressed between the fixing flange 11 and the frame 1 when the switching device 50 is in an operational state.

Operational state is understood to mean a nominal operating state in which the various pieces are assembled and tightened at the nominal torque.

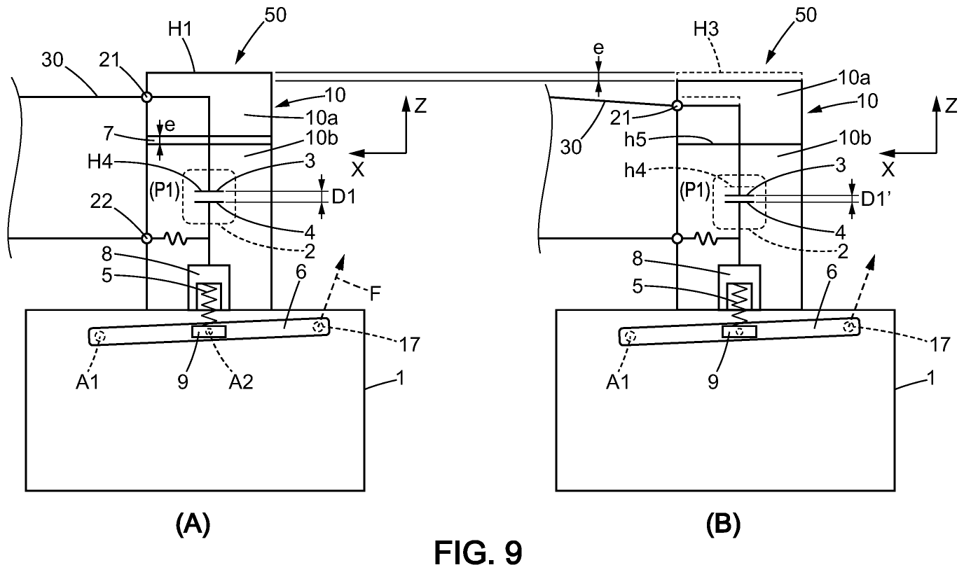

According to another embodiment of the switching device 50, illustrated in FIG. 9, the receiving enclosure 10 comprises a first portion 10a fixed to the frame 1 and a second portion 10b fixed to the first portion 10a,

and the at least one removable spacer 7 is arranged between the first portion 10a and the second portion 10b of the receiving enclosure 10.

The receiving enclosure is in two parts, and is formed by assembling the first portion 10a and the second portion 10b. A first face of the removable spacer 7 is in contact with the first portion 10a. A second face of the removable spacer 7, opposite to the first face, is in contact with the second portion 10b of the receiving enclosure 10. The removable spacer 7 is compressed between the first portion 10a and the second portion 10b when the switching device 50 is in an operational state.

In FIG. 9, the dashed line denoted by the sign h3 represents the position of the upper edge of the first portion 10a of the enclosure 10 when the removable spacer 7 is mounted. The sign h4 represents the position of the fixed electrode 3 when the removable spacer 7 is mounted. The sign h5 represents the position of the upper edge of the second portion 10b. This position does not change between part A of FIG. 9, in which the spacer 7 is mounted, and part B in which the spacer 7 is removed.

The displacement towards the bottom of the first portion 10a when the spacer 7 is removed causes the open distance of the electrodes to change from the distance D1 to the distance D1′ which is less than D1.

FIG. 4 shows one exemplary embodiment.

According to the example of FIG. 4, a lateral edge 15 of the removable spacer 7 is flush with a lateral edge 14 of the fixing flange 11.

The fixing flange 11 of the receiving enclosure 10 has the general shape of a rectangle here.

According to one embodiment variant, not shown, a lateral edge 15 of the removable spacer 7 protrudes from a lateral edge of the fixing flange 11.

It is thus easy to check for the presence or absence of the removable spacer 7, since the lateral edge 15 of the spacer 7 protrudes beyond the fixing flange 11, or is flush with the latter. The edge of the spacer 7 can therefore be easily seen by an operator when the spacer 7 is present. In the same way, the absence of the spacer 7 is easy to notice. Monitoring operations are thus made easier.

The at least one removable spacer 7 comprises a notch 12 for passage of a fixing means 13 for fixing the receiving enclosure 10 to the frame 1.

The notch 12 extends along a direction transverse to a main axis X of the removable spacer 7.

The spacer 7 may thus be put in place without completely removing the fixing means 13. It is enough to loosen the fixing means 13 in order to allow the insertion of the spacer 7 between the frame 1 and the fixing flange 11. In the same way, the spacer 7 may be withdrawn from the switching device 50 without removing the fixing means 13 by loosening them enough to allow the spacer 7 to be freed.

According to the example of FIGS. 3 and 4, the fixing flange 11 of the receiving enclosure 10 has a rectangular shape and comprises four fixing means 13 for fixing to the frame 1. Each fixing means 13 is arranged substantially at a corner of the rectangle defined by the fixing flange 11.

The fixing means 13 are, for example, screws.

Here, the fixing flange 11 comprises four fixed inserts 16 in which the fixing screws 13 are received. The inserts 16 can be seen in FIG. 4, which is a transparent view.

The spacer 7 may take various geometric shapes.

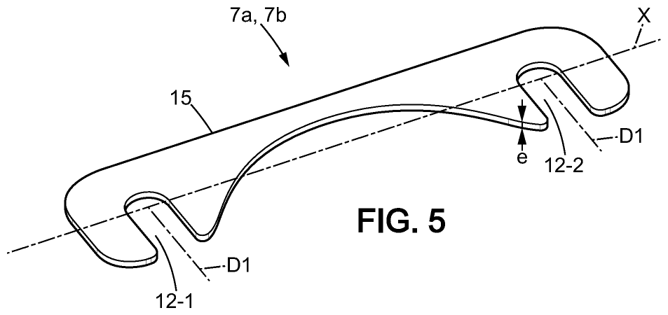

According to the embodiment of FIG. 4 and of FIG. 5, the at least one removable spacer comprises a first plate 7a and a second plate 7b, each plate 7a, 7b comprising a first notch 12-1 for passage of a first fixing means 13 for fixing the receiving enclosure 10 to the frame 1 and a second notch 12-2 for passage of a second fixing means 13 for fixing the receiving enclosure 10 to the frame 1.

The first plate 7a is arranged facing a first lateral edge of the fixing flange 11 and the second plate 7b is arranged facing a second lateral edge of the fixing flange 11.

When the fixing flange 11 has a rectangular or square shape and comprises four fixing means 13, a spacer 7 comprising two plates 7a, 7b may be easily arranged and ensures a good contact surface with the frame 1, on the one hand, and with the fixing flange 11, on the other hand.

The two plates 7a, 7b are, for example, planar.

The two planar plates 7a, 7b are, for example, identical.

Each plate 7a, 7b comprises a straight edge 15 which is set up to be flush with a lateral edge 14 of the fixing flange 11 when the plate 7a, 7b is present between the frame 1 and the receiving enclosure 10.

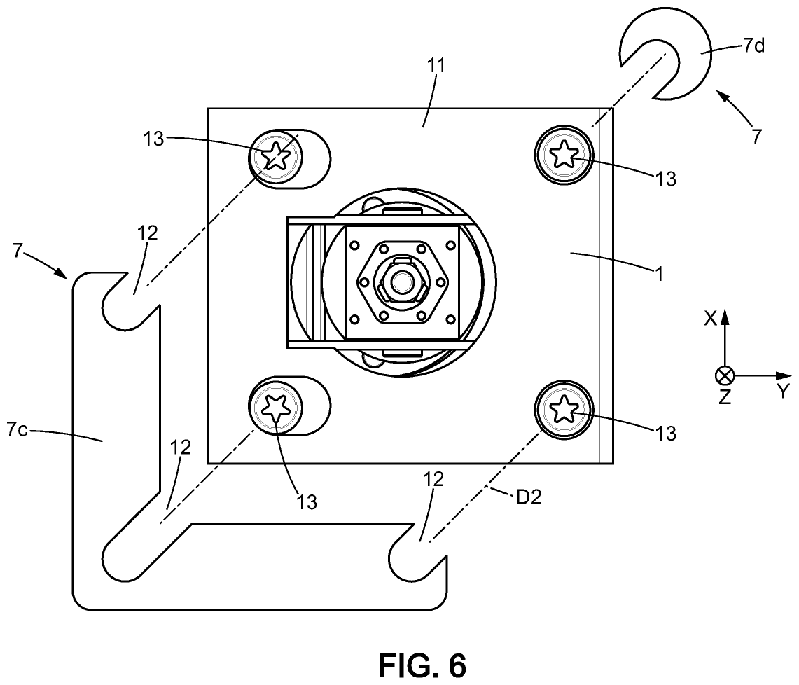

According to another embodiment variant, illustrated in FIG. 6, the at least one removable spacer 7 comprises an L-shaped portion 7c, the L-shaped portion 7c comprising three notches 12 for passage of a fixing means 13.

The at least one removable spacer 7 also comprises a U-shaped portion 7d. The portion 7d has the shape of an open ring allowing the passage of a fixing means 13.

In FIG. 6, the direction D2 illustrates the direction in which the portion 7c is displaced so as to be inserted between the frame 1 and the fixing flange 11.

The portion 7d may be inserted along a different direction of approach, since this portion 7d comprises a single passage notch.

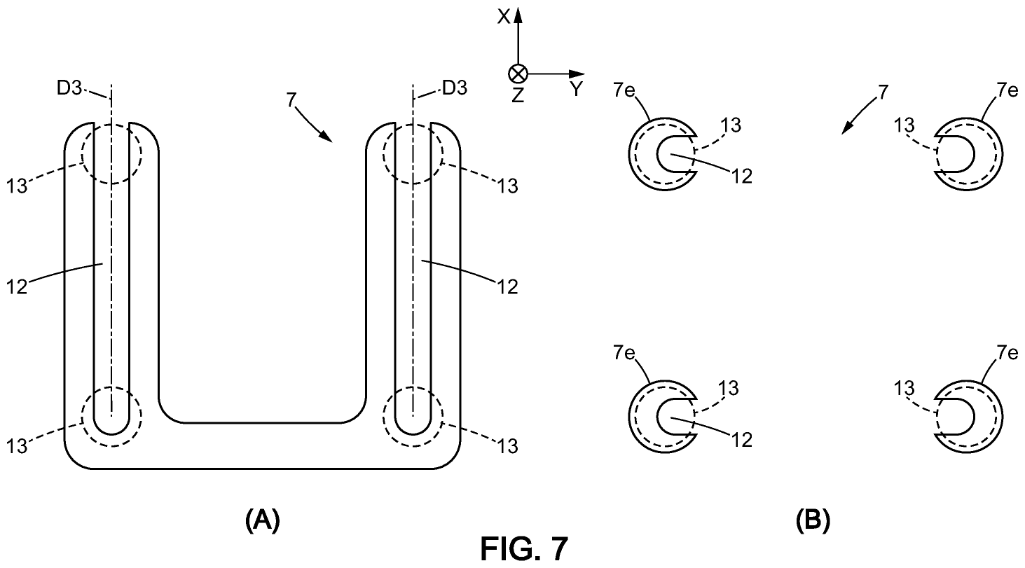

According to another embodiment variant, illustrated in part A of FIG. 7, the spacer 7 is U-shaped and comprises two parallel branches connected by a base extending transversely across the branches.

Each branch comprises a passage notch 12 for the passage of the fixing means 13.

Each passage notch 12 extends parallel to the corresponding branch. The direction D3 schematizes the direction in which the spacer 7 is displaced so as to be inserted between the frame 1 and the fixing flange 11. The direction D3 coincides with the extension axis of each passage notch 12.

The position of these fixing means is schematized by the dashed circles denoted by the sign 13.

According to yet another embodiment variant, illustrated in part B of FIG. 7, the removable spacer 7 comprises four separate elements 7e.

According to one embodiment of the switching device 50, not shown, the at least one removable spacer 7 comprises a stack of at least two plates.

In other words, two superposed spacers may be inserted.

In this case, it is possible, over the course of the life of the switching device 50, to remove a first plate so as to compensate for a first level of loss of overstroke of the contacts of the electrodes 3,4 while leaving the second plate in place.

Later in the life of the switching device 50, the second plate may also be removed, so as to compensate for a second level of loss of contact overstroke, greater than the first level.

The operation of compensating for the wear and for the ageing may thus be carried out twice over the course of the life of the switching device, this making it possible to compensate for a larger amount of loss of contact overstroke.

According to one embodiment of the electrical unit 100, each switching device 50, 50′, 50″ comprises at least one removable spacer 7, 7′, 7″ which is separate from the at least one removable spacer of the other switching devices.

In other words, each switching device 50, 50′, 50″ comprises its own removable spacer, or its own removable spacers, depending on the type of embodiment employed.

The at least one removable spacer may be present for the switching device equipping one phase of the electrical circuit, and absent for the switching device equipping another phase of the electrical circuit.

According to another embodiment, the electrical unit 100 comprises at least one removable spacer 7 which is shared by the three switching devices 50, 50′, 50″.

In this case, one and the same removable spacer is arranged between the three switching devices 50, 50′, 50″.

The removable spacer is thus simultaneously present for all the switching devices, or simultaneously absent for all the switching devices.

The removable spacer may, for example, have a shape similar to the shape of part A of FIG. 7, repeated three times along a direction transverse to the direction D3.

1. A switching device for a medium-voltage electrical circuit, comprising:
a frame,
a vacuum circuit breaker comprising a fixed electrode relative to the frame and a mobile electrode,
an elastic member,
an actuating lever connected to the mobile electrode via the elastic member,
the actuating lever being movable between a first position called open position in which the mobile electrode and the fixed electrode are separated by an open distance, and a second position called closed position in which the mobile electrode and the fixed electrode are in contact so as to allow current to flow through the electrical circuit,
a passage of the actuating lever from the first position to the second position defining a displacement stroke,
the displacement stroke of the actuating lever being greater than the open distance such that the elastic member is compressed when the actuating lever passes from the first position to the second position,
wherein the switching device comprises at least one removable spacer arranged between the frame and the fixed electrode so as to adjust the distance between the fixed electrode and the frame by removing the removable spacer.

2. The switching device according to claim 1, comprising a device for determining a difference between the displacement stroke of the actuating lever and the open distance of the mobile electrode with respect to the fixed electrode.

3. The switching device according to claim 1, wherein the actuating lever is connected to the mobile electrode via an insulator, and wherein the actuating lever is connected to the mobile electrode via a control plate in pivot connection with the control lever.

4. The switching device according to claim 1, comprising a receiving enclosure fixed to the frame, wherein the vacuum circuit breaker is arranged in the receiving enclosure, and wherein the fixed electrode is rigidly connected to the receiving enclosure.

5. The switching device according to claim 4, wherein the at least one removable spacer is arranged between the receiving enclosure and the frame.

6. The switching device according to claim 4, wherein the at least one removable spacer is arranged between a fixing flange, for fixing the receiving enclosure to the frame, and the frame.

7. The switching device according to claim 4, wherein the receiving enclosure comprises a first portion fixed to the frame and a second portion fixed to the first portion,
and wherein the at least one removable spacer is arranged between the first portion and the second portion of the receiving enclosure.

8. The switching device according to claim 4, wherein the at least one removable spacer comprises a notch for passage of a fixing means for fixing the receiving enclosure to the frame.

9. The switching device according to claim 4, wherein the at least one removable spacer comprises a first plate and a second plate, each plate comprising a first notch for passage of a first fixing means for fixing the receiving enclosure to the frame and a second notch for passage of a second fixing means for fixing the receiving enclosure to the frame.

10. The switching device according to claim 1, wherein the at least one removable spacer comprises a stack of at least two plates.

11. A three-phase medium-voltage electrical unit, comprising for each phase a switching device according to claim 1.

12. The electrical unit according to claim 11, wherein each switching device comprises at least one removable spacer which is separate from the at least one removable spacer of the other switching devices.

13. The electrical unit according to claim 11, comprising at least one removable spacer which is shared by the three switching devices.
